(19) United States
(12) Patent Application Publication
(10) Pub. No.: US 2002/0075005 A1
(43) Pub. Date: Jun. 20, 2002

(54) Apparatus for synchronously displaying patterns on panels during testing

(75) Inventor: Jion-Iou Hong, Hsinchu (TW)

Correspondence Address: DARBY & DARBY P.C., 805 Third Avenue, New York, NY, 10022, US

(73) Assignee: Hannstar Display Corp.

(21) Appl. No.: 10/045,958

(22) Filed: Oct. 24, 2001

(30) Foreign Application Priority Data
Dec. 19, 2000 (TW) 89127249

(51) Int. Cl. G01N 27/34

(52) U.S. Cl. 324/440

(57) ABSTRACT

The present invention provides an apparatus for synchronously displaying patterns on panels during testing wherein the panels are driven by SG cards. The apparatus comprises a synchronization activator generating a first signal, a pattern selector generating a second signal identifying one of the patterns, and a controller connected to the SG cards and simultaneously activating the SG cards driving all the panels to display the pattern identified by the second signal when receiving the first signal.

### BACKGROUND OF THE INVENTION

1. Field of the Invention

The present invention relates to an apparatus for pattern testing of panels, particularly to an apparatus for synchronously displaying patterns on panels during testing.

2. Description of the Prior Art

The conventional modular pattern testing tools used in aging or temperature and humidity testing chambers do not have synchronizing capability. Panels during testing are driven by SG cards power supplied by a control box. The control box is only used as a power supply and is not capable of synchronizing the SG cards driving the panels to display the pattern. Thus, each of the panels operates independently.

Additionally, the patterns cannot be freely switched in the conventional testing tools. There is no external controller provided to operators for pattern selecting. The displayed patterns are predetermined by the SG cards.

However, consumers concerned with panel performance usually require a demonstration of simultaneous display of a selected pattern by all the panels during testing for clear comparison at a glance. This demonstration is impossible for conventional testing tools.

### SUMMARY OF THE INVENTION

Therefore, the object of the present invention is to provide a testing tool capable of synchronously displaying a selected pattern on panels during testing.

The present invention provides an apparatus for synchronously displaying patterns on panels during testing wherein the panels are driven by SG cards. The apparatus comprises a synchronization activator generating a first signal, a pattern selector generating a second signal identifying one of the patterns, and a controller connected to the SG cards and simultaneously activating the SG cards driving all the panels to display the pattern identified by the second signal when receiving the first signal.

### BRIEF DESCRIPTION OF THE DRAWINGS

The following detailed description, given by way of example and not intended to limit the invention solely to the embodiments described herein, will best be understood in conjunction with the accompanying drawings, in which:

FIG.1 is a diagram showing a testing tool according to one embodiment of the invention.

FIG.2 is a circuit block diagram showing a testing tool according to one embodiment of the invention.

FIG.3 is a diagram showing connections of pins of SG cards according to one embodiment of the invention.

FIG.4 is a diagram showing a control unit of a controller according to one embodiment of the invention.

### DETAILED DESCRIPTION OF THE INVENTION

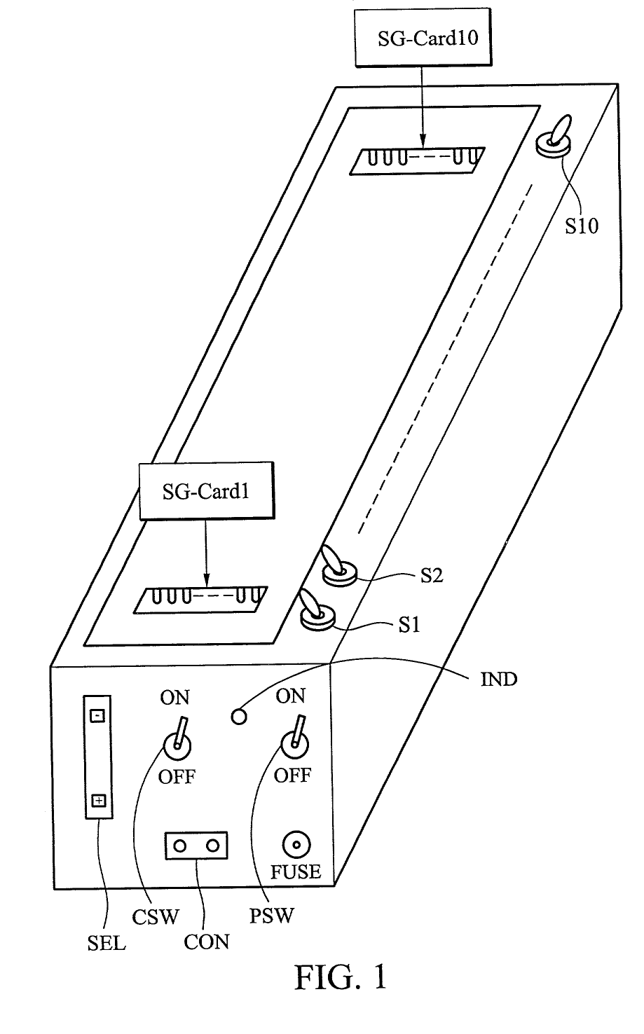

FIG.1 is a diagram showing a testing tool according to one embodiment of the invention.

The testing tool comprises 10 slots for SG cards 1˜10. On the panel board of the testing tool there are; a pattern selecting switch SEL, a synchronizing activating switch CSW, a power switch PSW, a BNC terminal CON for power supply, an indicating light IND, and a fuse and power switches for SG cards 1˜10.

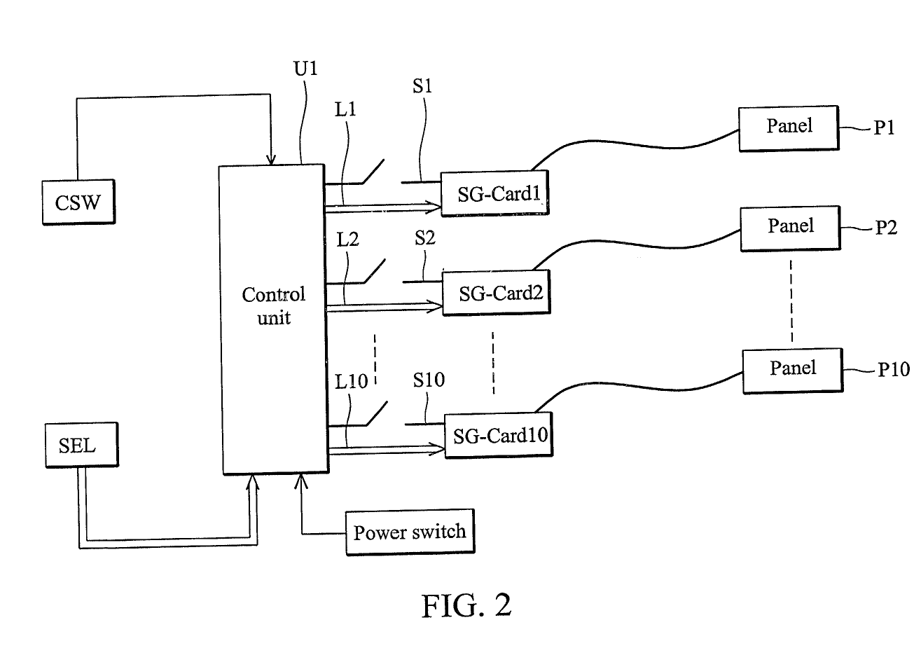

FIG.2 is a circuit block diagram showing a testing tool according to one embodiment of the invention.

The testing tool of the embodiment synchronously displays patterns on panels P1˜P10 during testing wherein the panels P1˜P10 are driven by SG cards 1˜10 respectively. The testing tool comprises a synchronization activating switch CSW used as a synchronization activator generating a synchronizing signal, a pattern selecting switch SEL used as a pattern selector generating a selecting signal identifying one of the patterns, and a control unit U1 connected to the SG cards 1˜10 and simultaneously activating the SG cards 1˜10 driving all the panels P1˜P10 to display the pattern identified by the selecting signal when receiving the synchronizing signal.

The testing tool also comprises a general power switch PSW and power switches S1˜S10 of the SG cards for connection to the power supply. The pattern selecting switch SEL is a BCD (Binary Coded Decimal)keypad.

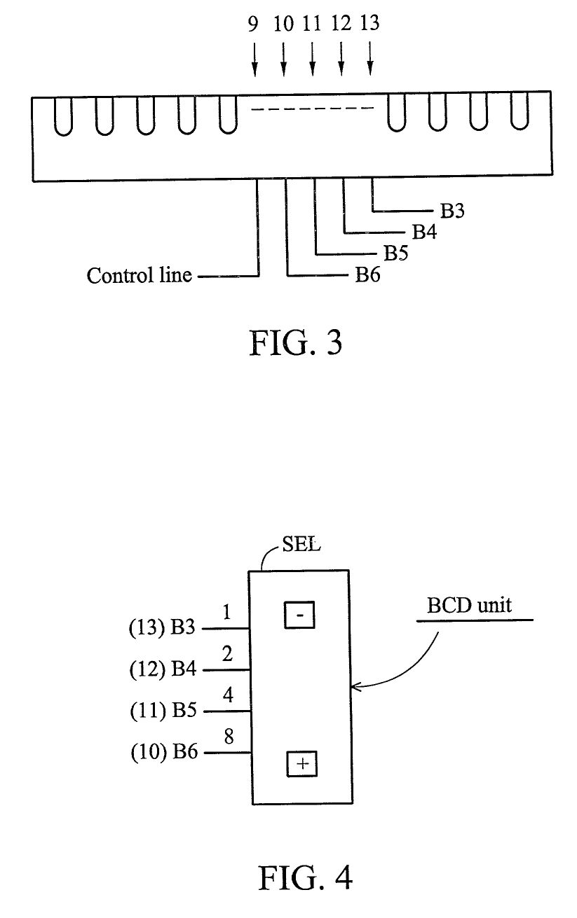

FIG.3 is a diagram showing connections of pins of SG cards according to one embodiment of the invention.

Lines L1˜L10 are connected to the pins of the SG cards 1˜10 and each of them comprises a control line CS and four signal lines B3˜B6. All the 9^{th} pins of the SG cards 1˜10 are connected to the control line CS for synchronously activating the SG cards 1˜10 to drive the panels P1˜P10 to display one of the patterns. The 10^{th}, 11^{th}, 12^{th} and 13^{th} pins of all the SG cards 1˜10 are connected to the signal lines B3, B4, B5 and B6 respectively.

FIG.4 is a diagram showing a control unit of a controller according to one embodiment of the invention.

The control unit U1 comprises a BCD unit sending signals to the 10^{th}, 11^{th}, 12^{th}, and 13^{th} pins of the SG cards 1˜10. The 16 combinations of the binary signals on the 10^{th}, 11^{th}, 12^{th}, and 13^{th} pins of the SG cards 1˜10 represent hexadecimal numbers 0˜F identifying 16 patterns respectively. The logic levels of the binary signals are determined by the selecting switch SEL.

In conclusion, the present invention provides a testing tool having a controller receiving a synchronizing and selecting signal generated by a synchronization activating and pattern selecting switch respectively. The controller simultaneously activates SG cards driving all panels to display a pattern identified by the selecting signal when receiving the synchronizing signal. Thus, a demonstration of simultaneously displaying of the selected pattern on all the panels during testing for a clear comparison at a glance is made practical.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for synchronously displaying patterns on panels during testing wherein the panels are driven by SG cards, the apparatus comprising:
a synchronization activator generating a first signal;
a pattern selector generating a second signal identifying one of the patterns; and
a controller connected to the SG cards and simultaneously activating the SG cards driving all the panels to display the pattern identified by the second signal when receiving the first signal.

2. The apparatus as claimed in claim 1 wherein the controller further comprises a BCD control unit connected to the SG cards.

3. The apparatus as claimed in claim 1 wherein the pattern selector is a BCD keypad.

4. The apparatus as claimed in claim 1 further comprising a power switch.

5. The apparatus as claimed in claim 1 further comprising a plurality of power switches for the SG cards.
